(19) United States
(12) Patent Application Publication
(10) Pub. No.: US 2025/0388365 A1
(43) Pub. Date: Dec. 25, 2025

(54) LINER FOR FREEZE DRYING TRAY

(71) Applicants: William Albert Mann, Strome (CA); Brigitte Candace Mann, Strome (CA)

(72) Inventors: William Albert Mann, Strome (CA); Brigitte Candace Mann, Strome (CA)

(21) Appl. No.: 18/747,708

(22) Filed: Jun. 19, 2024

(51) Int. Cl. B65D 25/14; B65D 1/34

(52) U.S. Cl. CPC B65D 25/14; B65D 1/34

(57) ABSTRACT

A tray liner configured to be operably coupled to a tray wherein the tray is utilized to receive food thereon and placed in a freeze drying appliance. The present invention includes a bottom member that is mateably sized and shaped to a tray on which the tray liner is superposed. Extending upward from the bottom member being perpendicular thereto are the sidewall members. The sidewall members are adjacent sidewalls of the tray to which the present invention is operably coupled. Contiguously formed with the sidewall members distal to the bottom member is the upper edge member. The upper edge member is comprised of a first portion and a second portion with the first portion extending outward from the sidewall member being perpendicular thereto. The second portion is perpendicular to the first portion and has formed on the inner surface thereof a retention member.

### FIELD OF THE INVENTION

The present invention relates generally to freeze drying products, more specifically but not by way of limitation, a liner for a tray that is utilized in the freeze-drying process wherein the liner of the present invention includes a bottom having integrally formed sidewalls wherein the sidewalls are further contiguously formed with upper edge members having retention members to ensure maintenance of position of the liner subsequent being operably coupled to a tray.

### BACKGROUND

Freeze-drying is one of the fastest-growing methods of home food preservation. Lyophilization or freeze drying is a process in which water is removed from a product after it is frozen and placed under a vacuum, allowing the ice to change directly from solid to vapor without passing through a liquid phase. The process consists of three separate and interdependent processes: freezing, sublimation and desorption. Freeze drying food preserves the quality and flavor with a unique texture and the food will have a shelf life of 20 to 25years. Freeze-dried food is lightweight and portable but rehydrates to the same flavor and texture as the original food. Most foods can be freeze dried which includes but is not limited to milk, eggs, meat, fruits, vegetables, and whole-prepared meals. Since freeze-dried food maintains more nutrients than any other food preservation method, it's also increasingly popular with the health-conscious.

The freeze-drying process is fairly simple which begins with food preparation and then the food is placed on the trays and inserted into a freeze-drying machine. Once inside the freeze-drying chamber, the machine drops the temperature to around −30 to −50 F. Once the food is at temperature, a vacuum pump drops the pressure inside the chamber. Next, a small heating element built into the tray rack gently warms the food on the trays so that the tray is warmer than the ambient temperature, this initiates the drying process. Freeze drying removes around ninety eight percent of the water in food, effectively stopping spoilage and stabilizing freeze-dried food for approximately twenty-five years. While effective, there are intrinsic problems to the tray wherein liners thereof only cover the bottom and are ineffective for liquids.

Accordingly, there is a need for a liner for a tray that is utilized in the freeze-drying process wherein the liner of the present invention includes a bottom having integrally formed sidewalls wherein the sidewalls are further contiguously formed with upper edge members having retention members to ensure maintenance of position of the liner subsequent being operably coupled to a tray

### SUMMARY OF THE INVENTION

It is the object of the present invention to provide a liner for a tray that is employed in the freeze-drying process wherein the liner of the present invention includes a body manufactured from a pliable non-stick material.

Another object of the present invention is to provide a tray liner configured to be operably coupled with a tray wherein the tray is employed in the freeze-drying process wherein the liner includes a bottom portion.

A further object of the present invention is to provide a liner for a tray that is employed in the freeze-drying process wherein the bottom portion includes a perimeter edge.

Yet a further object of the present invention is to provide a tray liner configured to be operably coupled with a tray wherein the tray is employed in the freeze-drying process wherein the liner includes sidewall members contiguously formed with the bottom portion proximate the perimeter edge thereof.

Still another object of the present invention is to provide a liner for a tray that is employed in the freeze-drying process wherein the sidewall members extend upward from the bottom portion and are perpendicular therewith.

An additional object of the present invention is to provide a tray liner configured to be operably coupled with a tray wherein the tray is employed in the freeze-drying process wherein the sidewall members have contiguously formed therewith upper edge members that are operable surroundably mount the upper edge of a tray.

Yet a further object of the present invention is to provide a liner for a tray that is employed in the freeze-drying process wherein the upper edge members further include a retention member formed on a portion thereof.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a cross-sectional view of the present invention operably coupled with a tray; and

FIG. 2 is a cross-sectional of the present invention; and

FIG. 3 is a perspective view of the present invention operably coupled with a tray.

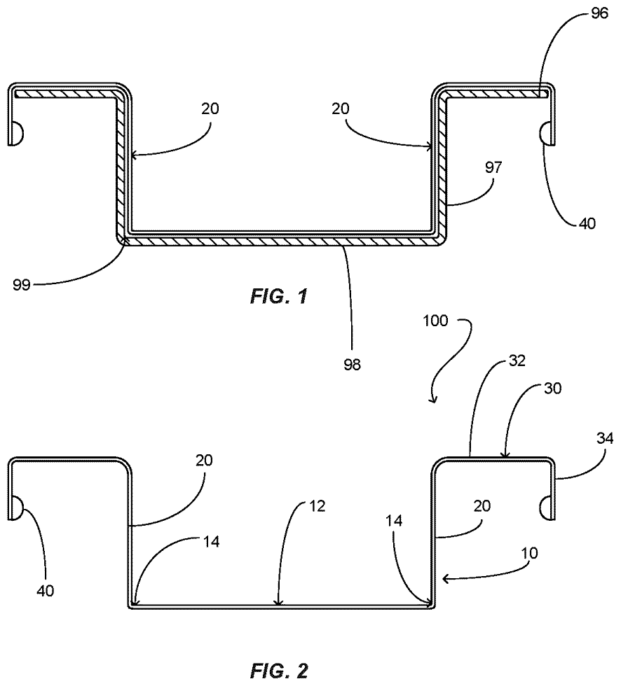

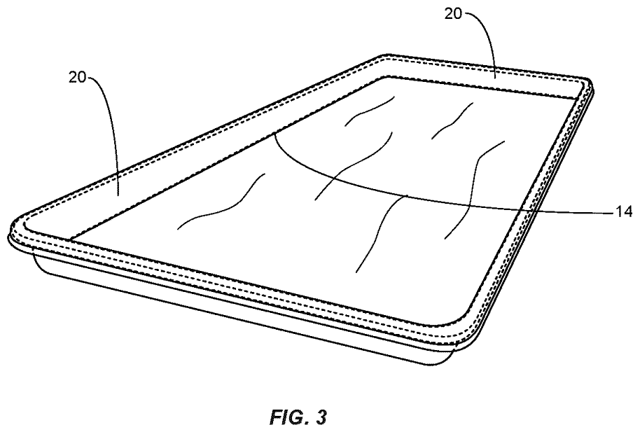

### DETAILED DESCRIPTION

Referring now to the drawings submitted herewith, wherein various elements depicted therein are not necessarily drawn to scale and wherein through the views and figures like elements are referenced with identical reference numerals, there is illustrated a tray liner 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References embodiment “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the tray liner 100 is configured to be operably coupled with exemplary tray 99 wherein the tray 99 is utilized in the process of freeze drying food and is inserted into a suitable freeze drying appliance. It should be understood within the scope of the present invention that the tray liner 100 is mateably shaped to the tray 99 and as such could be manufactured in alternate sizes and shapes in addition to the exemplary illustrations submitted as a part hereof. Furthermore, in a preferred embodiment the tray liner 100 is manufactured from silicon but it is contemplated within the scope of the present invention that alternate suitable materials could be utilized.

The tray liner 100 includes a body 10 having bottom member 12. Bottom member 12 is planar in manner having perimeter edge 14. The bottom member 12 is configured to be adjacent bottom 98 of tray 99. The bottom member 12 is mateably shaped to bottom 98 so as to provide complete coverage thereof. Integrally formed with the bottom member 12 are the sidewall members 20. The sidewall members 20 extend upward from the bottom member 12 at the perimeter edge 14. Sidewall members 20 are perpendicular to the bottom member 12. The sidewall members 20 are formed to provide coverage of the sidewalls 97 of the tray 99.

Integrally formed with the sidewall members 20 distal to the perimeter edge 14 are upper edge members 30. The upper edge members 30 are comprised of a first portion 32 and second portion 34. First portion 32 of the upper edge members 30 are perpendicular to the sidewall member 20 extending outward therefrom. The second portion 34 of the upper edge members 30 is contiguously formed with the first portion 32 distal to the sidewall member 20. Second portion 34 is perpendicular to the first portion 32 extending downward therefrom and is parallel to the sidewall member 20.

Formed on the inner surface of the second portion 34 is retention member 40. Retention member 40 is contiguously formed with the second portion 34 being manufactured from the same material. Retention member 40 extends outward from the inner surface of the second portion 34 towards the sidewall member 20. In a preferred embodiment the retention member 40 is semi-annular in shape but it should be understood within the scope of the present invention that the retention member 40 could be provided in alternate shapes. The retention member 40 is operably to ensure maintenance of position of the tray liner 100 once operably coupled with tray 99 as the retention member 40 will engage tray lip 96 when lifted upwards.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A tray liner configured to be operably coupled with a tray that is utilized in a process of freeze drying food wherein the tray liner comprises:
a body, said body having a bottom member, said bottom member being planar in manner, said bottom member having a perimeter edge;
a plurality of sidewall members, said plurality of sidewall members being contiguously formed with said bottom member at the perimeter edge thereof, said plurality of sidewall members extending upward from said bottom member being perpendicular thereto;
an upper edge member, said upper edge member being contiguously formed with said plurality of sidewall members distal to said bottom member, said upper edge member having a first portion and a second portion, said first portion of said upper edge member being contiguous with said plurality of sidewall members, said first portion of said upper edge member extending outward from said plurality of sidewall members being perpendicular thereto, said second portion of said upper edge member being contiguous with said first portion distal from said plurality of sidewall members, said second portion being perpendicular with said first portion extending downward therefrom, said second portion of the upper edge member being parallel with said plurality of sidewall members.

2. The tray liner configured to be operably coupled with a tray as recited in claim 1, and further including a retention member, said retention member being formed on an inner surface of said second portion of said upper edge member, said retention member extending inward towards said plurality of sidewall members.

3. The tray liner configured to be operably coupled with a tray as recited in claim 2, wherein said retention member is semi-annular in shape.

4. The tray liner configured to be operably coupled with a tray as recited in claim 3, wherein said body is manufactured from silicon.
